(19) United States
(12) Patent Application Publication
(10) Pub. No.: US 2005/0267726 A1
(43) Pub. Date: Dec. 1, 2005

(54) Apparatus and method for prediction of image reality

(76) Inventors: Jin-Seo Kim, Daejon (KR); Maeng-Sub Cho, Daejon (KR); Hae-Dong Kim, Daejon (KR); Sung-Ye Kim, Daejon (KR); Byoung-Tae Choi, Daejon (KR); Hyun-Bin Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/187,137

(22) Filed: Jul. 22, 2005

(30) Foreign Application Priority Data
Apr. 11, 2004 (KR) 10-2004-0089141

(51) Int. Cl. H04N 17/00

(52) U.S. Cl. 703/23; 348/180

(57) ABSTRACT

An apparatus and a method for predicting reality of an image are provided. The apparatus includes: a prediction model generator for performing a psychophysical observer test on a plurality of first test images provided from outside and analyzing the test result to generate an image reality prediction model; a prediction model verifier for applying the image prediction model to a second test image provided from outside to predict image reality and comparing the prediction result with the test result to verify the image reality prediction model; and a reality prediction model applier for applying the verified image reality prediction model to a target evaluation image and providing the prediction result.

### FIELD OF THE INVENTION

The present invention relates to an apparatus and a method for predicting reality of an image; and, more particularly, to an apparatus and a method for predicting reality of an image to produce a high quality of image, wherein the image reality prediction is achieved through sequential operations of: pre-predicting reality and an overall quality of an image perceived by observers; producing a plurality of test images; performing a psychophysical observer test and generating an image reality prediction model; predicting reality of an actually produced test image by using the image reality prediction model; verifying the image reality prediction model; and predicting the reality of the produced image by applying the image reality prediction model to a target evaluation image which is the produced image.

### DESCRIPTION OF THE RELATED ART

Generally, producers who organize and supervise the making of a motion picture, play, broadcast or recording determine a quality of images produced through computer graphics for providing special effects in digital animations, digital broadcasting, motion pictures, or advertisements and produce images according to this subjective determination. Thus, degrees of reality and quality of the finally produced images provided by producers are different from each other, and there has been yet no objective method of determining degrees of reality and quality approved by viewers and consumers.

Also, a signal-to-noise ratio (SNR), which is commonly used for managing image quality in conventional broadcasting apparatuses, is a referential basis for determining a degree of distortion in an image when shown to viewers compared with an originally produced image. However, the SNR does not provide the evaluation on reality and quality of an image itself, but is rather a system for evaluating damage in a signal during transmission.

As for compressed digital images, a conventional method of evaluating a quality of a compressed image is more focused to evaluate whether human eyes are able to discriminate the compressed image from the original image. Thus, this conventional method does not provide the evaluation on reality of the image itself.

In conventional color science and color imaging fields, there have been vigorous studies on qualities and differences between a converted image through various conversion methods and an originally produced image. However, most of the studies have been emphasized on colors and certain objects within the image and mainly on pixel based measurements. Although many researchers have made attempts to evaluate overall reality and quality of an image, yet these attempts are still in an initial stage insufficient to be applied to an actual practice.

### SUMMARY OF THE INVENTION

It is, therefore, an object of the present invention to provide an apparatus and a method for predicting reality of an image through sequential operations of: generating an image reality prediction model through performing a psychophysical observer test with respect to a plurality of test images and analyzing the result of the psychophysical observer test; verifying the image reality prediction model; and applying the image reality prediction model to an actually produced image for a target evaluation.

In more detail of the sequential operations for the image reality prediction, a plurality of first test images are converted by using predetermined parameters affecting the image reality. Then, the converted first test images are displayed sequentially on a monitor used for the psychophysical observer test, which is subsequently applied to observers who are statistically classified into a similar group, and the test data are collected and analyzed through a color science based analysis method to generate an image reality prediction model. Afterwards, the image reality prediction model is applied to a second test image to predict reality of the second test image and, this prediction result is compared with the psychophysical observer test result, thereby verifying accuracy of the image reality prediction model. The image reality prediction model is then applied to a produced image actually targeted for the reality evaluation, thereby outputting the reality prediction result of the produced image. Accordingly, this image reality prediction makes a contribution to provide an enhanced quality of image contents.

In accordance with an aspect of the present invention, there is provided an apparatus for predicting reality of an image, including: a prediction model generator for performing an observer test on a plurality of first test images provided from outside and analyzing the test result to generate an image reality prediction model; a prediction model verifier for applying the image prediction model to a second test image provided from outside to predict image reality and comparing the prediction result with the test result to verify the image reality prediction model; and a reality prediction model applier for applying the verified image reality prediction model to a target evaluation image and providing the prediction result.

In accordance with another aspect of the present invention, there is provided a method for predicting reality of an image, including the steps of: converting a plurality of first test images by using various parameters; displaying the converted first test images and performing an observer test on the displayed images; sorting data of the observer test result and analyzing the sorted data through a color science based analysis method to generate an image reality prediction model; applying the image reality prediction model to a second test image to predict reality of the second test image and comparing the prediction result with the observer test result to verify the image reality prediction model; and applying the verified image reality prediction model to a target evaluation image and outputting the prediction result of the target evaluation image.

### BRIEF DESCRIPTION OF THE DRAWINGS

The above and other objects and features of the present invention will become apparent from the following description of the preferred embodiments given in conjunction with the accompanying drawings, in which:

FIG. 1 is a configuration diagram showing an apparatus for predicting reality of an image in accordance with a preferred embodiment of the present invention;

FIG. 2 is a detailed configuration diagram showing a prediction model generator of FIG. 1;

FIG. 3 is a detailed configuration diagram showing a prediction model verifier of FIG. 1;

FIG. 4 is a configuration diagram showing an image converting block of FIG. 2;

FIG. 5 is a detailed configuration diagram showing an observer testing block of FIG. 2;

FIG. 6 is a configuration diagram showing a test result analyzing block of FIG. 2; and

FIG. 7 is a flowchart for describing a method for predicting reality of an image in accordance with the preferred embodiment of the present invention.

### DETAILED DESCRIPTION OF THE PREFERRED EMBODIMENTS

Reference will now be made in detail to the preferred embodiments of the present invention, examples of which are illustrated in the accompanying drawings. It should be noted that the same reference numerals will be used for the same configuration elements even in different drawings.

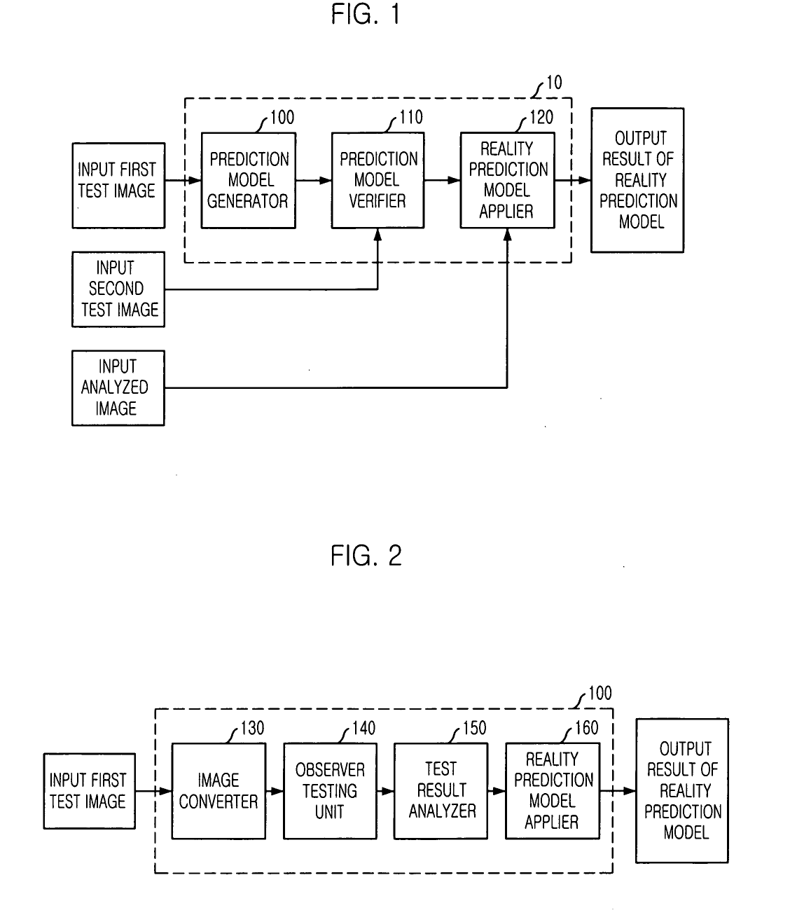

FIG. 1 is a configuration diagram showing an image reality prediction apparatus in accordance with a preferred embodiment of the present invention.

Referring to FIG. 1, an image reality prediction apparatus 10 includes: a prediction model generator 100; a prediction model verifier 110; and a reality prediction model applier 120. Especially, the prediction model generator 100 carried out an observer test on a plurality of first test images inputted from outside and analyzes the test result to generate an image reality prediction model. Herein, the observer test is specifically a psychophysical observer test. The prediction model verifier 110 applies the image reality prediction model generated from the prediction model generator 100 to a second test image inputted from outside to predict the image reality and, compares the prediction result with the observer test result to verify accuracy of the image reality prediction model. The reality prediction model applier 120 applies the image reality prediction model verified by the prediction model verifier 110 to a produced image actually targeted for a reality evaluation and then outputs the reality prediction result.

In more detail, the generation of the image reality prediction model starts with inputting the plurality of first test images obtained from various environments to the prediction model generator 100 of the image reality prediction apparatus 10. Then, the prediction model generator 100 converts the plurality of first test images into predetermined images and carried out the psychophysical observer test on the converted first test images. Afterwards, the prediction model generator 100 analyzes the test result data and generates the image reality prediction model and then, transmits the image reality prediction model to the prediction model verifier 110.

Next, the prediction model verifier 110 predicts reality of the second test image inputted from outside by using the image reality prediction model and compares this prediction result with the result of the psychophysical observer test to verify the image reality prediction model. After the verification, the prediction model verifier 110 transmits the image reality prediction model to the reality prediction model applier 120.

Then, the reality prediction model applier 120 carries out the reality prediction operation by applying the verified image reality prediction model to the produced image actually targeted for the reality evaluation and outputs the reality prediction result.

FIG. 2 is a detailed configuration diagram showing the prediction model generator of FIG. 1.

As shown, the prediction model generator 100 includes: an image converting block 130; an observer testing block 140; a test result analyzing block 150; and a reality prediction model generating block 160. Particularly, the image converting block 130 converts the plurality of first test images inputted from outside into images used for a psychophysical observer test. The observer testing block 140 performs the psychophysical observer test for a generation of an image reality prediction model on the converted first test images. The test result analyzing block 150 analyzes the test result data provided from the observer testing block 140 based on a color science based analysis method and generates data necessary for generating the image reality prediction model. Through using the test result analysis data from the test result analyzing block 150, the reality prediction model generating block 160 generates a mathematical model, that is, the image reality prediction model, for predicting reality of an image.

More specific to the sequential operations of the image reality prediction model generation, the image converting block 130 first performs an image conversion of the first test images to generate images compatibly used for the psychophysical observer test. Then, the observer testing block 140 performs the psychophysical observer test for generating the image reality prediction model on the converted first test images provided from the image converting block 130. Also, the observer testing block 140 transmits data of the psychophysical test result to the test result analyzing block 150, which in turn, generates analyzed data necessary for the image reality prediction model based on the color science based analysis method and then transmits the analyzed data to the reality prediction model generating block 160. On the basis of the analyzed data, the reality prediction model generating block 160 generates the image reality prediction model, which is transmitted to the prediction model verifier 110 thereafter.

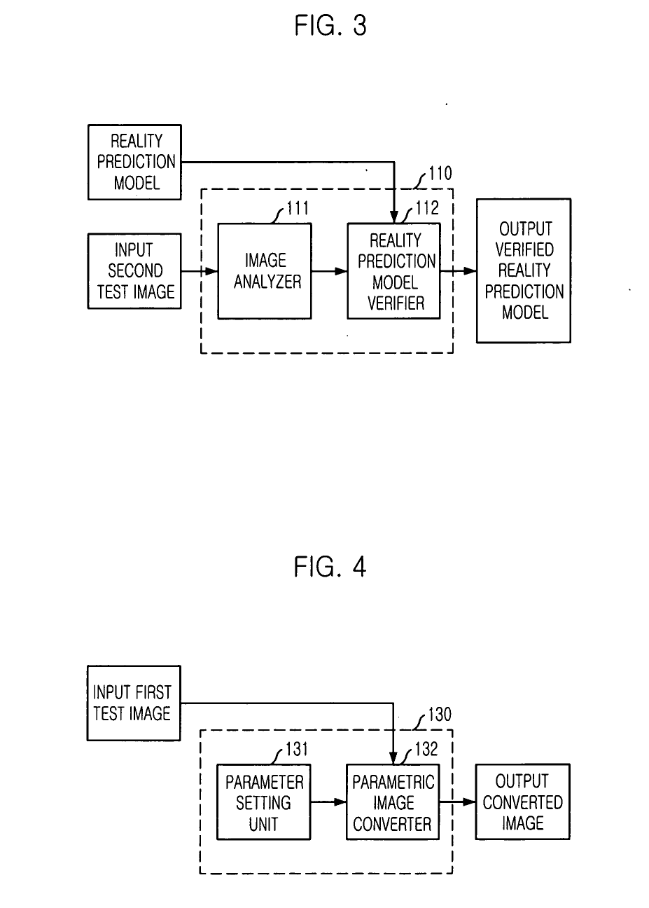

FIG. 3 is a detailed configuration diagram showing the prediction model verifier of FIG. 1.

The prediction model verifier 110 includes: an image analyzing unit 111 for analyzing a second test image provided from outside for each parameter related to the image reality; and a reality prediction model verifying unit 112 for applying the image reality prediction model transmitted from the prediction model generator 100 to the image analysis result inputted from the image analyzing unit 111 to predict reality of the second test image and comparing the prediction result of the second test image with the psychophysical observer test result to verify accuracy of the image reality prediction model.

In more detail of the sequential operations of verifying the image reality prediction model, the prediction model verifier 110 receives the image reality prediction model from the prediction model generator 100 and the second test image from outside. Then, the image analyzing unit 111 performs the image analysis for each related parameter and transmits the image analysis result to the reality prediction model verifying unit 112. Then, the reality prediction model verifying unit 112 predicts reality of the second image by using the inputted image analysis result and image reality prediction model and compares the reality prediction result with the psychophysical observer test result for the verification of the image reality prediction model. Also, the reality prediction model verifying unit 112 transmits the inputted image reality prediction model to the realty prediction model applier 120 thereafter.

FIG. 4 is a configuration diagram showing the image converting block of FIG. 2.

As illustrated, the image converting block 130 includes: a parameter setting unit 131 for setting a parameter for the psychophysical observer test among pre-defined parameters related to the reality of an image by human visual perception; and a parametric image converting unit 132 for converting the first images through applying the parameter set by the parameter setting unit 131.

Specifically, the parameter setting unit 131 sets a parameter applied for the psychophysical observer test among various pre-defined parameters related to the image reality perceived by human eyes including lightness, chroma, contrast, sharpness, blurriness, image compression and image noise.

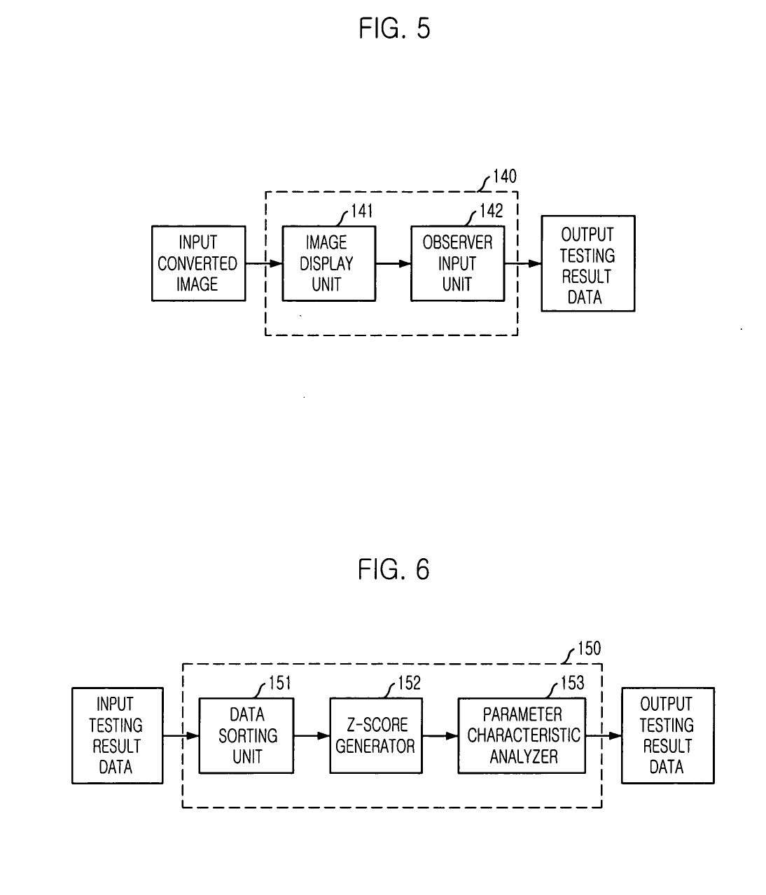

FIG. 5 is a detailed configuration diagram showing an observer testing block of FIG. 2.

The observer testing block 140 includes: an image display unit 141 for sequentially displaying the converted first test images provided from the image converting block 130 on a display device; and an observer input unit 142 to which answers for image reality related questions about the displayed images are inputted by the observers.

As for the sequential operations for the psychophysical observer test, the observer testing block 140 sequentially displays the plurality of converted first test images through the image display unit 141, which receives the plurality of converted first test images from the image converting block 130 and then, displays the converted first test images sequentially on the display device and, carries out the psychophysical observer test as receiving answers for a series of image reality related questions about the displayed first test images from the observers through the observer input unit 142 and outputs the test result data thereafter.

At this time, the observer testing block 140 carries out the psychophysical observer test by asking questions after displaying one image on the display device and receiving answers, or by asking questions after displaying two images on the display device and receiving answers.

For instance, the questions related to the image reality include the following details for each of the above described testing methods.

First, in the case of carrying out the psychophysical observer test by asking questions after displaying two images on the display device and receiving the answers, the details of the questions are as follows.
A. Are the two displayed images the same in overall?
B. Are colors of the two displayed images the same?
C. Are sharpness of the two displayed images the same?
D. Are textures of the two displayed images the same?

Second, in the case of carrying out the psychophysical observer test by asking questions after displaying one image on the display device and receiving the answers, the details of the questions are as follows.
A. In what degree the displayed image exhibits the overall reality?
B. In what degree the displayed image exhibits the color reality?
C. In what degree the displayed image exhibits the texture reality?

Also, observers are asked to answer the image reality related questions in the following manners depending on the question types. In the case of receiving the answers for the questions after two images are displayed on the display device, the answer type is ‘Yes’ or ‘No.’ In the case of receiving the answers for the questions after one image is displayed on the display device, the answer type is a scale of 1 to 5._The scale ‘1’ indicates the farthest answer from the question, whereas the scale ‘5’ indicates the closest answer from the question. The middle scales of 2 to 4 indicate the neutral answer for the question.

FIG. 6 is a detailed configuration diagram showing the test result analyzing block of FIG. 2.

As shown, the test result analyzing block 150 includes: a data sorting unit 151 for receiving the psychophysical observer test result data outputted from the observer testing block 140 and sorting the test result data into an appropriate form for generating Z-scores; a Z-score generating unit 152 for generating Z-score data, which are statistical analysis results, through using the sorted data inputted from the data sorting unit 151; and a parameter characteristic analyzing unit 153 for setting a factor value for a prediction of image reality for each reality perception parameter based on the Z-score data provided from the Z-score generating unit 152 and outputting the set factor value as an analysis result data.

In more detail of the sequential operations of the analysis for the psychophysical test result data, the test result analyzing block 150 first receives the test result data from the observer testing block 140 and sorts the received data into an appropriate form for the Z-score generation by employing the data sorting unit 151 that sorts the psychophysical test result data for the data analysis. Then, the Z-score generating unit 152 generates Z-score data by using the sorted data. The Z-score data generated from the Z-score generating unit 152 are inputted to the parameter characteristic analyzing unit 153, which in turn, sets a factor value for a prediction of image reality for each reality perception parameter through the use of the Z-score data and outputs the set factor value as an analysis result data thereafter.

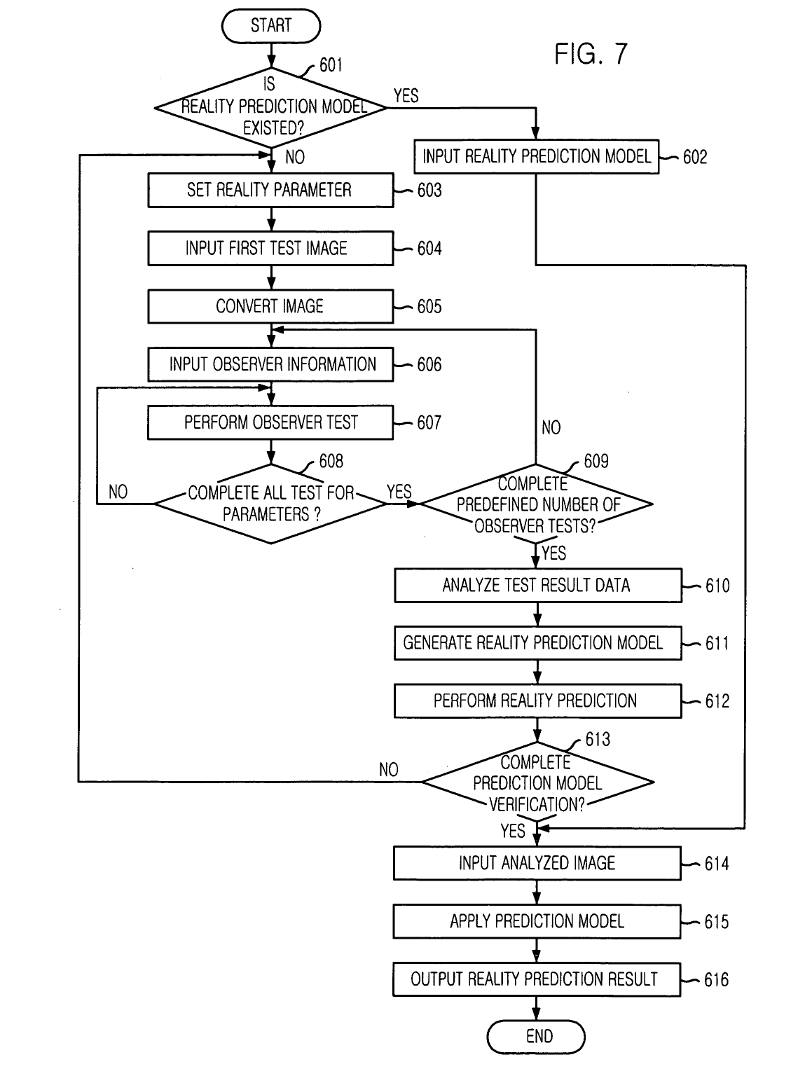

FIG. 7 is a flowchart for describing an image reality prediction method in accordance with the preferred embodiment of the present invention.

First, a plurality of first test images are converted by using numerous parameters. Then, the converted first test images for a psychophysical observer test are sequentially displayed and afterwards, the psychophysical observer test is performed with respect to the displayed first test images. The collected test result data are sorted and applied with a color science based analysis method, thereby generating an image reality prediction model.

Subsequently, the image reality prediction model is applied to a second test image to carry out an operation of predicting the image reality and, this prediction result is compared with the psychophysical observer test result to verify the performance of the image reality prediction model.

Next, the verified image reality prediction model is applied to a produced image actually targeted for the image reality evaluation to predict the reality of the produced image. Afterwards, the prediction result is outputted thereafter.

With reference to FIG. 7, detailed description of the above described sequential steps of the reality prediction will be provided hereafter.

First, at step 601, it is determined whether a precedently generated image reality prediction model exists. If the answer is positive, at step 602, the precedent image reality prediction model is provided and carries out an operation of predicting reality of an image to be evaluated at step 614. If the precedent image reality prediction model does not exist, at step 603, a reality parameter for an image conversion is set to generate images used for the psychophysical observer test for generating an image reality prediction model.

Afterwards, at step 604, a plurality of first test images for the image conversion are inputted through the set reality parameters. Then, at step 605, the inputted first test images are converted by using the set reality parameters.

At step 606, pieces of information on observers for the psychophysical observer test, are inputted to carry out the observer test with use of the converted first test images at step 607. It is then determined at step 608 whether the observer test for all parameters is completed with respect to one observer. If the observer test is completed, at step 609, it is checked whether the observer test is completed with respect to all observers. If the observer test is not completed for all parameters, the step 607 of carrying out the observer test is repeated. Meanwhile, if the observer test is completed for all observers, at step 610, an analysis of the test result data is investigated. If the observer test is not completed for all observers, the observer test is repeatedly applied for other observers at step 606.

Upon the completion of the observer test data analysis at 610, the image reality prediction model is generated at step 611 through employing the analysis result. Then, the generated image reality prediction model is applied for a second test image to predict reality of the second test image at step 612. The prediction result and the observer test result data are compared with each other to verify the image reality prediction model at step 613. If the verification is not completed, the steps from ‘603’ to ‘613’ are repeated. If otherwise, a target evaluation image is inputted for an actual evaluation at step 614 and then, applied with the image reality prediction model at step 615. As a result, at step 615, the reality prediction result is inputted and afterwards, the sequential operations of the image reality prediction apparatus are completed.

The above described image reality prediction method can be recorded into a computer readable recording medium as being implemented in the form of a program. Examples of such computer readable recording medium include read-only memory (ROM), random access memory (RAM), compact disc-ROMs, floppy disks, hard disks, magnetic disks and so forth. The recording of the image reality prediction method will not be described in detail since the serial recording of the computer readable recording medium can be easily derivable by those ordinary people skilled in the art.

On the basis of the preferred embodiment of the present invention, parameters related to the reality of an image by human visual perception are analyzed through a psychophysical observer test and, the test result was analyzed based on a color science based analysis method to output the image reality perceived by viewers and consumers in a certain quantified value. The above standardized systematic workflow provides an effect that conventional image quality evaluation methods providing a mathematical analysis result based on a physical difference, for instance, a signal-to-noise ratio and an analysis on a difference between pixels of a digital image, cannot provide. That is, the standardized systematic workflow can provide the subjectively evaluated overall image quality in an objective numerical value. Also, since the image reality prediction model is generated based on a statistically similar group of observers, it is possible to maintain the test result with high reliability.

Also, when the standardized reality prediction tools are used in various fields of digital image content productions such as digital animations, digital broadcasting, advertisements, and motion pictures, it is possible to eliminate the possibility of decreasing an image quality because of a difference in quality perceived by viewers and by producers. That is, if producers make images referring to the image reality prediction result through using the standardized reality prediction tool, the produced image can be provided to viewers with an approved level of reality, and as a result, the image quality can be reasonably improved.

The present application contains subject matter related to Korean patent application No. 10-2004-0089141, filed in the Korean Intellectual Property Office on Nov. 4, 2004, the entire contents of which is incorporated herein by reference.

While the present invention has been described with respect to the particular embodiments, it will be apparent to those skilled in the art that various changes and modifications may be made without departing from the scope of the invention as defined in the following claims.

1. An apparatus for predicting reality of an image, comprising:
a prediction model generator for performing a psychophysical observer test on a plurality of first test images provided from outside and analyzing the test result to generate an image reality prediction model;
a prediction model verifier for applying the image prediction model to a second test image provided from outside to predict image reality and comparing the prediction result with the test result to verify the image reality prediction model; and
a reality prediction model applier for applying the verified image reality prediction model to a target evaluation image and providing the prediction result.

2. The apparatus as recited in claim 1, wherein the prediction model generator includes:
an image converting block for converting the plurality of first test images into images used for the observer test;
an observer testing block for performing the observer test on the converted first test images;
a test result analyzing block for analyzing data of the test result from the observer testing block through using a color science based analysis method to generate data necessary for generating the image reality prediction model; and
a reality prediction model generating block for generating the image reality prediction model by using the analysis result inputted from the test result analyzing block.

3. The apparatus as recited in claim 2, wherein the image converting block includes:
a parameter setting unit for setting a parameter used for the observer test among pre-defined parameters related to the reality of an image by human visual perception; and
a parametric image converting unit for applying the set parameter to the plurality of first test images to perform the image conversion.

4. The apparatus as recited in claim 3, wherein the parameter setting unit sets a parameter among the pre-defined reality related parameters including lightness, chroma, contrast, sharpness, blurriness, image compression and image noise.

5. The apparatus as recited in claim 2, wherein the observer testing unit includes:
an image display unit for receiving the converted first test images and displaying the received first test images in sequential order on a display device; and
an observer input unit for receiving answers for reality related questions about the displayed first test images from observers.

6. The apparatus as recited in claim 5, wherein the observer testing unit performs the observer test by receiving answers for questions provided after one image is displayed on the display device.

7. The apparatus as recited in claim 5, wherein the observer testing unit performs the observer test by receiving answers for questions provided after two images are displayed on the display device.

8. The apparatus as recited in claim 2, wherein the test result analyzing block includes:
a data sorting unit for receiving data of the test result from the observer testing unit and then sorting the data in an appropriate form for generating Z-scores;
a Z-score generating unit for generating Z-scores, which are statistical analysis measurements, by using the sorted data inputted from the data sorting unit; and
a parameter characteristic analyzing unit for setting a factor value for predicting reality of an image for each reality perception parameter by using the corresponding Z-score inputted from the Z-score generating unit and outputting the set factor value as an analysis result data.

9. The apparatus as recited in claim 1, wherein the prediction model verifier includes:
an image analyzing unit for analyzing the second test image for each parameter related to the image reality; and
a reality prediction model verifying unit for applying the image reality prediction model inputted from the prediction model generator to the image analysis result inputted from the image analyzing unit to predict reality of the second image and comparing the prediction result with the test result to verify accuracy of the image reality prediction model.

10. A method for predicting reality of an image, comprising the steps of:
converting a plurality of first test images by using various parameters;
displaying the converted first test images and performing a psychophysical observer test on the displayed images;
sorting data of the observer test result and analyzing the sorted data through a color science based analysis method to generate an image reality prediction model;
applying the image reality prediction model to a second test image to predict reality of the second test image and comparing the prediction result with the observer test result to verify the image reality prediction model; and
applying the verified image reality prediction model to a target evaluation image and outputting the prediction result of the target evaluation image.
